(19) United States
(12) Patent Application Publication
(10) Pub. No.: US 2007/0120792 A1
(43) Pub. Date: May 31, 2007

(54) GAMMA-CORRECTION CIRCUIT AND DISPLAY PANEL CONTROL CIRCUIT

(75) Inventors: Hisashi Sasaki, Kawasaki-shi (JP); Yoshihide Nakajima, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/563,075

(22) Filed: Nov. 24, 2006

(30) Foreign Application Priority Data
Nov. 29, 2005 (JP) 2005-344416

(51) Int. Cl. G09G 3/36

(52) U.S. Cl. 345/89

(57) ABSTRACT

A gamma-correction circuit, comprising a gamma-reference voltage generation circuit capable of outputting voltages from connection nodes between a plurality of first resistor units connected in cascade, a gamma-correction voltage generation circuit configured to output gray level voltages from connection nodes between a plurality of second resistor units connected in cascade, the second resistor units having the same circuit configuration as the gamma-reference voltage generation circuit and having the same resistance ratio as that of the plurality of first resistor units, and at least one buffer connected between at least one connection node of the gamma-reference voltage and the corresponding connection node of the gamma-correction voltage.

### CROSS REFERENCE TO RELATED APPLICATIONS

This application is based upon and claims the benefit of priority from the prior Japanese Patent Application No. 2005-344416, filed on Nov. 29, 2005, the entire contents of which are incorporated herein by reference.

### BACKGROUND OF THE INVENTION

1. Field of the Invention

The present invention relates to a gamma-correction circuit and a display panel control circuit which adjust voltages in accordance with gamma-correction characteristic.

2. Related Art

A drive circuit that drives a liquid-crystal panel supplies signal lines aligned in rows in the liquid-crystal panel with voltages in accordance with gray levels. The supply voltage is determined in accordance with types of a liquid-crystal panel. Relationship between the supply voltage and the gray level depends also on the types of a liquid-crystal panel. The reason of such dependence is the fact that physical phenomenon is different according to LCD modes such as OCB (Optical Compensated Birefringence) and IPS (In-Plane-Switching), and thus the display results are different.

Characteristic standards such as sRGB, ITU709, and SMPTE240M have brightness characteristic for the target gray level. Gamma correction specifies how voltages should be supplied to respective gray levels in order to provide a specific brightness characteristic.

In other words, the gamma correction specifies the voltages for gray levels. In general, with accuracy of 6-bit display, the gamma-correction characteristic is approximated by broken lines consisting of a collection of straight lines. In contrast, for global allocation of gray level with 8-bit accuracy, the straight lines cannot well approximate characteristics for gamma correction. Accordingly, an accurate gray level reproduction is problematic especially for black (lower brightness) levels when watching TV images by a cellular phone.

In a gamma-correction characteristic, more numbers of gray levels is generally allocated to lower brightness than higher brightness. That is, its sampling points of gray levels are denser for lower brightness voltages than for higher brightness voltages. Thus, the simple approximation of gamma correction with a broken line is not always appropriate.

An adjustment technique has been disclosed (refer to Japanese Patent Laid-Open No. 2001-166751). In this art, currents is supplied for liquid-crystal panel to measure the characteristic, and then a user can programmably move tap points in a broken line so as to change the correction characteristic.

In the technique disclosed in Japanese Patent Laid-Open No. 2001-166751, as a voltage is forced to set its level by supplying more extra current flow, the larger the adjustment is, the larger the consumption power becomes. From this understanding, when power consumption is required to be reduced in an apparatus such as a cellular phone, it is not desirable to utilize the technique disclosed in Japanese Patent Laid-Open No. 2001-166751.

There are inherent gamma-correction curves respectively for companies that manufacture liquid-crystal-panel. Actually, the types of gamma-correction curves considerably changes depending on a manufacturing company Therefore, the voltage control is requested in the voltage application according to each gamma-correction curve for the driver IC that drives a liquid-crystal panel.

An accuracy-raising technique has been proposed (refer to Japanese Patent Laid-Open No. 2005-10276) where a gamma-correction curve is approximated with a broken line. The technique utilizes variable resistors whose resistance values are changeable at the VDD side and the GND side. Increasing and decreasing of the resistance values adjusts a broken line up or down in order to approximate the gamma-correction curve. However, when a characteristic is adjusted by increasing and decreasing the resistance values of the variable resistors, its small range of adjustment is recognized as a problem in performing the adjustment.

On the other hands, another approach has been also proposed. In this approach, an arbitrary voltage is generated by the data stored in a memory in advance, so that the characteristic of the gamma-correction curve for a liquid-crystal panel can arbitrarily be adjusted when a user mounts a driver IC (refer to U.S. Pat. No. 6836232).

However, an additional memory and its associated peripheral circuit are required: for example, an associated switch is required to programmably select a generated voltage based on the memory data. Therefore, the size of the hardware increases.

From the viewpoint of manufacturing a driver IC, essential prerequisite is a fine adjustment of a gamma-correction characteristic. An arbitral all-mighty flexibility itself which drastically changes the characteristic of the driver IC is unnecessary for the gamma-correction characteristic. On the other hands, lowest power operation is prioritized rather than all-mighty flexibility when a mass-produced driver IC is adjusted to its best condition. In this understanding, however, by considering the fact that the difference of gamma-correction characteristics depends on respective liquid-crystal-panel manufacturing companies, a driver IC is desirable to have responsibility for the adjustment of a gamma-correction characteristic.

### SUMMARY OF THE INVENTION

According to one embodiment of the present invention, a gamma-correction circuit, comprising:

a gamma-reference voltage generation circuit capable of outputting voltages from connection nodes between a plurality of first resistor units connected in cascade;

a gamma-correction voltage generation circuit configured to output gray level voltages from connection nodes between a plurality of second resistor units connected in cascade, the second resistor units having the same circuit configuration as the gamma-reference voltage generation circuit and having the same resistance ratio as that of the plurality of first resistor units; and

at least one buffer connected between at least one connection node of the gamma-reference voltage and the corresponding connection node of the gamma-correction voltage.

According to one embodiment of the present invention, a display panel control circuit, comprising:

a latch circuit configured to latch digital pixel data including gray level information;

a gray level voltage generation circuit configured to generate gray level voltages;

a D/A converter configured to select the gray level voltage in accordance with a bit value of the digital pixel data latched by the latch circuit; and

an output circuit configured to adjust output level of the D/A converter to supply the output level to the corresponding signal line in a display panel,

wherein the gray level voltage generation circuit has a gamma correction circuit configured to correct voltage levels of a plurality of reference voltages in conformity to gamma-correction characteristics of the display panel to generate the gray level voltages, the gamma correction circuit including:

a gamma-reference voltage generation circuit capable of outputting the voltages from the connection nodes between a plurality of first resistor units connected in cascade;

a gamma-correction voltage generation circuit configured to output the gray level voltages from the connection nodes between a plurality of second resistor units connected in cascade, the second resistor units having the same resistance ratio as that of the first resistor units, the gamma-correction voltage generation circuit having the same circuit configuration as that of the gamma-reference voltage generation circuit; and

at least one buffer connected between at least one connection node of the gamma -reference voltage generation circuit and the connection node of the gamma-correction voltage generation circuit.

### BRIEF DESCRIPTION OF THE DRAWINGS

FIG. 1 is a block diagram schematically illustrating the configuration of a gamma-correction circuit according to Embodiment 1 of the present invention;

FIG. 2 illustrates an example of the connection form;

FIG. 3 is a diagram illustrating an example in which reserve unit-resistors are provided;

FIG. 4 is a diagram illustrating an example in which three reserved unit-resistors are arranged in a row;

FIG. 5 is a block diagram illustrating an example of a gamma-correction circuit in which the connection position can be changed (re-wired) programmably for the operational amplifier 3;

FIG. 6 is a diagram illustrating an example in which all the output voltages inputted to the selector 7 are replaced for the gamma-reference-voltage generation circuit 1;

FIG. 7 is a block diagram illustrating gamma-correction circuit in which all the output voltages, of the gamma-reference-voltage generation circuit 1, that are inputted to the selector 7 have been replaced;

FIG. 8 is a block diagram illustrating the configuration of a gamma-correction circuit corresponding to a plurality of kinds of liquid-crystal panels;

FIG. 9 is a flowchart illustrating an example of the procedure of gamma-correction processing according to the present embodiment;

FIG. 10 is a graph representing gamma-correction characteristic curves for four kinds of liquid-crystal panels produced by manufacturing companies A, B, C, and D;

FIG. 11 is a graph representing the results of the normalization;

FIG. 12 is a graph representing the relationship between the gray level value and the resistance value when the step is 0.5;

FIG. 13 is a graph representing the relationship between the gray level value and the resistance when the step is one: the respective resistor units have no parallel-connected unit-resistors;

FIG. 14 is a graph representing the result obtained by the processing in Step S5 in FIG. 10;

FIG. 15A is a list representing the accumulated resistance values at respective connection nodes in the gamma-reference-voltage generation circuit 1 or the gamma-correction-voltage generation circuit 2 corresponding to a liquid-crystal panel manufactured by Company A;

FIG. 15B is a list representing the accumulated resistance values at respective connection nodes corresponding to a liquid-crystal panel manufactured by Company B;

FIG. 15C is a merged list in which the respective groups of accumulated values in FIGS. 15A and 15B are rearranged in increasing order;

FIG. 16A is a list representing the resistor string in FIG. 15C in another expression;

FIG. 16B is a list representing the resistor string in FIG. 15C in another expression;

FIG. 16C is a list representing the resistor string in FIG. 15C in another expression;

FIG. 17 is a diagram of integrating the results for FIGS. 16A to 16C;

FIG. 18 is a diagram illustrating a method of selecting a reference voltage;

FIG. 19 is a schematic block diagram of gamma-correction circuit when gamma-correction voltages are generated for a single type of liquid-crystal panel;

FIG. 20 is a schematic block diagram of gamma-correction circuit when gamma-correction voltages are generated for two types of liquid-crystal panels;

FIG. 21 is a diagram for explaining the approach more specifically. At the left side, there are eight reference voltages 5A, 44A, 55A, 62A, 67A, and 71A corresponding to the liquid-crystal panel supplied from Company A;

FIG. 22 is a diagram schematically illustrating the configuration of gamma-correction circuit for realizing the approach illustrated in FIG. 21;

FIG. 23 is a block diagram schematically illustrating a variant configuration of the gamma-correction circuit in FIG. 22;

FIG. 24A-24B are a set of graphs representing the results of gamma correction performed according to Embodiment 1 or Embodiment 2 described above; and

FIG. 25 is a block diagram illustrating a schematic configuration of such a driver IC.

### DETAILED DESCRIPTION OF THE INVENTION

An embodiment of the present invention will be explained below, with reference to the accompanying drawings.

### EMBODIMENT 1

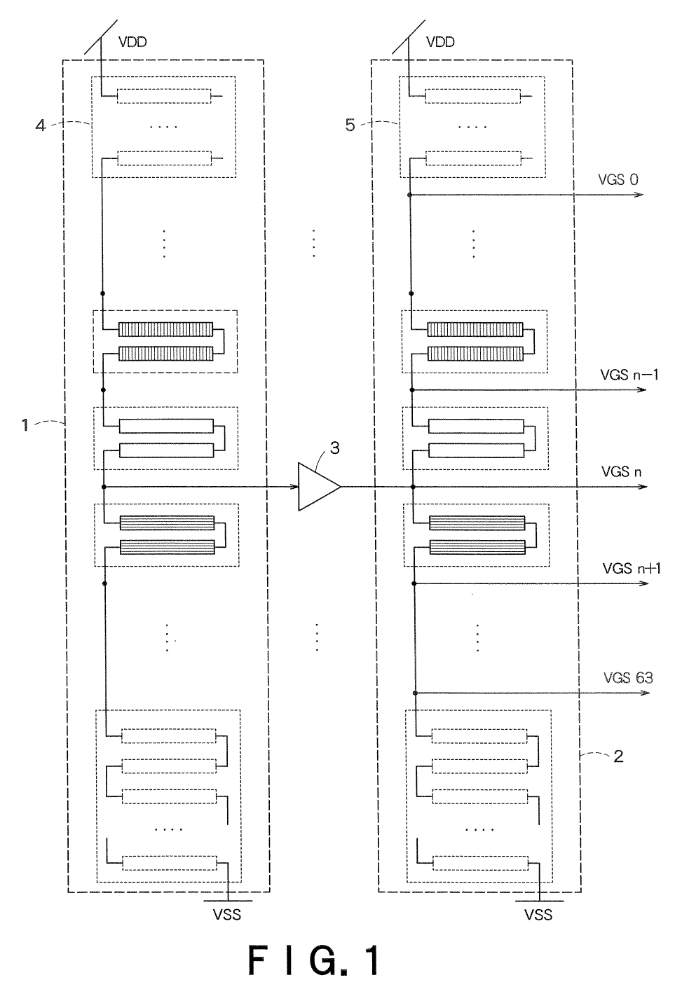

FIG. 1 is a block diagram schematically illustrating the configuration of a gamma-correction circuit according to Embodiment 1 of the present invention. The gamma-correction circuit in FIG. 1 includes a gamma-reference-voltage generation circuit 1, a gamma-correction-voltage generation circuit 2, and a plurality of operational amplifiers (or buffers) 3. The gamma-correction circuit of FIG. 1 is a master-slice gamma-correction circuit.

The gamma-reference-voltage generation circuit 1 has a resistor string consisting of a plurality of first resistor units 4 that are connected in cascade and outputs gamma-correction reference voltages from at least part of a plurality of connection nodes between neighboring first resistor units 4. Each of the plurality of first resistor units 4 has one or more resistance elements. Depending on each first resistor unit 4, there may be different number of internal resistance elements and different form of connection of the resistance elements. However, each of the resistance elements has the same resistance value. For example, as shown in the resistor units in FIG. 1, resistor units may consist of two or three resistance elements connected in series, or resistor units may consist of only a single resistance element.

The gamma-correction-voltage generation circuit 2 is configured with the same circuits as those in the gamma-reference-voltage generation circuit 1 The gamma-correction-voltage generation circuit 2 has a resistor string consisting of a plurality of second resistor units 5 that are connected in cascade. And the circuit 2 outputs the same number of gamma-correction voltages as gray levels from the nodes that connects two neighboring second resistor units 5. A power-supply voltage VDD is supplied to each terminal of the resistor strings in the gamma-reference-voltage generation circuit 1 and the gamma-correction-voltage generation circuit 2. Other terminals of resistor strings are connected to the ground voltage. Exactly speaking, as alternative driving scheme is popularly adopted for both the positive and negative characteristics with centering the common voltage, the above mentioned “ground voltage” should be shift by a corresponding voltage to the common voltage. Hereinafter, we will omit the detailed modification about such alternative driving of a gamma voltage for the sake of simplicity.

The same resistance values are given for the resistance elements that configure the plurality of second resistor units 5 in the gamma-correction-voltage generation circuit 2. Hereinafter, the resistance elements are called “unit-resistors”.

In the present embodiment, resistance ratio is forced to be equal for the resistor string in the two gamma-reference-voltage generation circuits 1 and 2. In this regard, however, the resistance values itself of each unit-resistor are not necessarily identical to each other in the two gamma-reference-voltage generation circuits 1 and 2. The respective resistance values of the unit-resistors should be set to optimal value by considering the trade-off between current consumption and driving current (or drivability).

For example, approximately 8 bits is required as the electrical resolution to obtain perceptual 64 gray levels. Thus, for example, 250 pieces of unit-resistors may be prepared because the integer 250 is close to 256. A resistor string is formed in a mater-slice way: the 250 pieces of same-sized unit-resistors are manufactured in advance as semi-manufactured IC by patterning on a semiconductor substrate, and then the terminals of the unit-resistors are connected with one another in a final personalization stage of an IC manufacturing process. To make the resistor string more flexible to adjust, preparation of extra unit-resistors is a good idea: for instance, 300 cascade-connecting unit-resistors may be prepared in advance.

Unit resistors are connected in a zigzag manner, e.g., as illustrated in FIG. 1. Single resistor unit may have a plurality of unit-resistors. The connections within unit-resistors are not necessarily the identical for the respective resistor units.

As described above, the two gamma-reference-voltage generation circuits 1 and 2 are formed in the same circuit configuration in which respective unit-resistors have the same “unit” resistance value. Therefore, two connection-node voltages are equal with each other for the resistor strings both in the gamma-reference-voltage generation circuits 1 and 2 As a result, such a simple configuration enables us to generate a high-accuracy gamma-correction voltage with a small voltage variation.

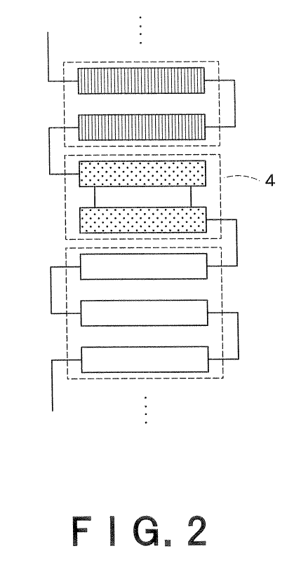

Various types of connection forms are available as resistance elements in the first resistor unit 4 and the second resistor unit 5. For example, FIG. 2 illustrates an example of the connection form: a resistor unit is configured with two parallel-connected unit-resistors. The combination of two or more parallel-connected unit-resistors can give a smaller resistance value than the series-connected unit-resistors, and thereby such combination enables fine adjustment of the output voltage.

In general, when displayed with 64-bit-gray level, eight bits are expected to be sufficient to generate gray level voltages. However, as human vision is sensitive for an intermediate gray levels, finer gray levels may be required for high-quality applications. Accordingly, it is effective to configure a resistor unit with parallel-connected unit-resistors as in FIG. 2. In addition, a single resistor unit can be configured through the combination of both series-connected unit-resistors and parallel-connected unit-resistors.

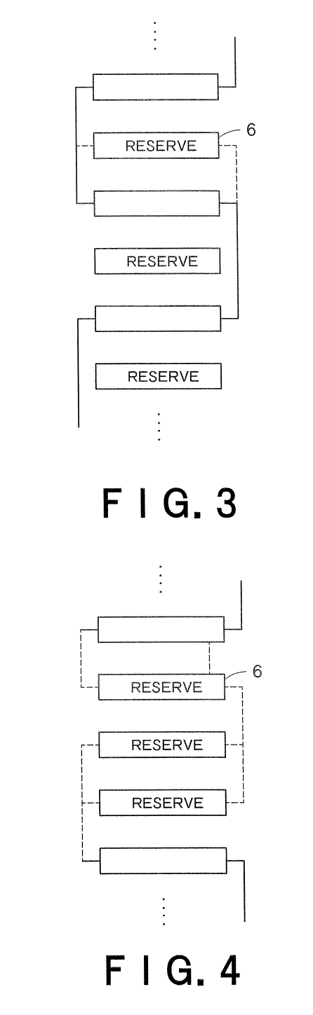

When a resistor unit is configured with a plurality of parallel-connected unit-resistors, in some cases, the connecting positions have to be changed by the wiring that connects the resistor unit and another resistor unit. In this regard, as illustrated in FIG. 3, parallel-connected unit-resistors are reserved as auxiliary preparation in advance. When the parallel-connected unit-resistor is formed in the resistor unit, a reserved unit-resistor 6 is utilized. In the example illustrated in FIG. 3, reserved unit-resistors are alternately arranged. Therefore, as need arises, two parallel-connected unit-resistors can configure arbitrary a resistor unit.

The larger number of parallel-connected unit-resistors is prepared, the smaller resistance value is available for the resistor unit, whereby adjustment of the output voltage can be performed more precisely. For example, FIG. 4 illustrates an example of a resistor unit in which three reserved unit-resistors 6 are arranged in a row.

An operational amplifier 3 in FIG. 1 receives a predetermined voltage outputted from the gamma-reference-voltage generation circuit 1. When the operational amplifier 3 outputs a signal with the equal voltage level to its input voltage, the operational amplifier 3 improves the drivability of the output signal. The output voltage signal sent from the operational amplifier 3, is supplied to a predetermined connection node in the gamma-correction-voltage generation circuit 2. More concretely, the output voltage of the operational amplifier 3 is supplied to the first connection node in the resistor string of the gamma-correction-voltage generation circuit 2. This first connection node corresponds to a predetermined second connection node that is connected with the input terminal of the operational amplifier 3 in the resistor string of the gamma-reference-voltage generation circuit 1.

The same circuits are respectively formed for the two gamma-reference-voltage generation circuit 1 and 2. In both the circuits, the same positions are used for both connection nodes that connect the operational amplifier 3 as input and output. Accordingly, the two voltages are equally balanced for the input voltage and the output voltage of the operational amplifier 3. As a result, the current reduction is achieved for the current that flows from the input to the output of terminal of the operational amplifier 3, whereby power consumption is reduced.

The operational amplifiers 3 are not provided for all the connection nodes in the gamma-reference-voltage generation circuit 1, but provided for every plurality of (e.g., eight) connection nodes. The characteristic for gamma correction is changed at the connection node in the gamma-correction-voltage generation circuit 2, to which the output voltage from the operational amplifier 3 is supplied.

The operational amplifier 3 in FIG. 1 connects respective predetermined connection nodes in the gamma-reference-voltage generation circuits 1 and 2. However, the connection position for the operational amplifier 3 may be changed programmably.

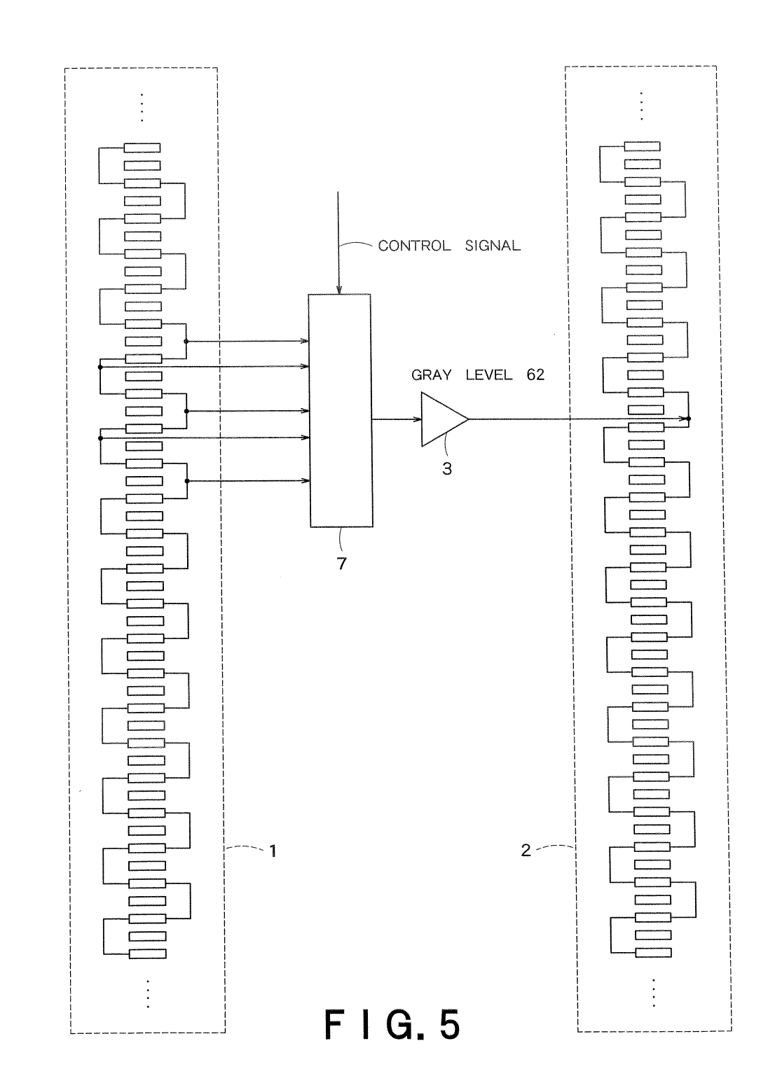

FIG. 5 is a block diagram illustrating an example of a gamma-correction circuit in which the connection position can be changed (re-wired) programmably for the operational amplifier 3. The gamma-correction circuit in FIG. 5 is configured with both the circuit in FIG. 1 and an additional selector 7. Based on an outer control signal, the selector 7 selects one of a plurality of voltages (in the case of FIG. 3, three kinds of neighboring voltages) which is outputted from the gamma-reference-voltage generation circuit 1.

The control signal, for example, corresponds to the type of a liquid-crystal panel for which gamma correction is to be performed. As the input voltage of the operational amplifier 3 can be set in accordance with the control signal, the optimal gamma correction is archived for each liquid-crystal panel.

In addition, when the selector 7 is provided as illustrated in FIG. 5, the switching of the selector 7 changes the connection node that is connected with the operational amplifier 3 in the gamma-reference-voltage generation circuit 1. Therefore, the switching of the selector 7 must change the connection position for the output terminal of the operational amplifier 3 to keep equal voltage balancing. However, in that case, as another additional selector must be provided between the output terminal of the operational amplifier 3 and the gamma-correction-voltage generation circuit 2, thereby complicating circuit configuration with larger size.

To avoid such complication, in the present embodiment, the connection node may be intentionally fixed at the output side of the operational amplifier 3. Therefore, a voltage difference of up to 4 steps is produced between the input side and the output side of the operational amplifier 3. However, as the voltage difference is not significant, it just slightly increases current dissipation, whereby no problem occurs.

As described above, by enabling control signal to switch the input voltage of the operational amplifier 3, a gamma-correction voltage is generated in order to match a plurality of types of gamma-correction characteristics, whereby the usability is enhanced.

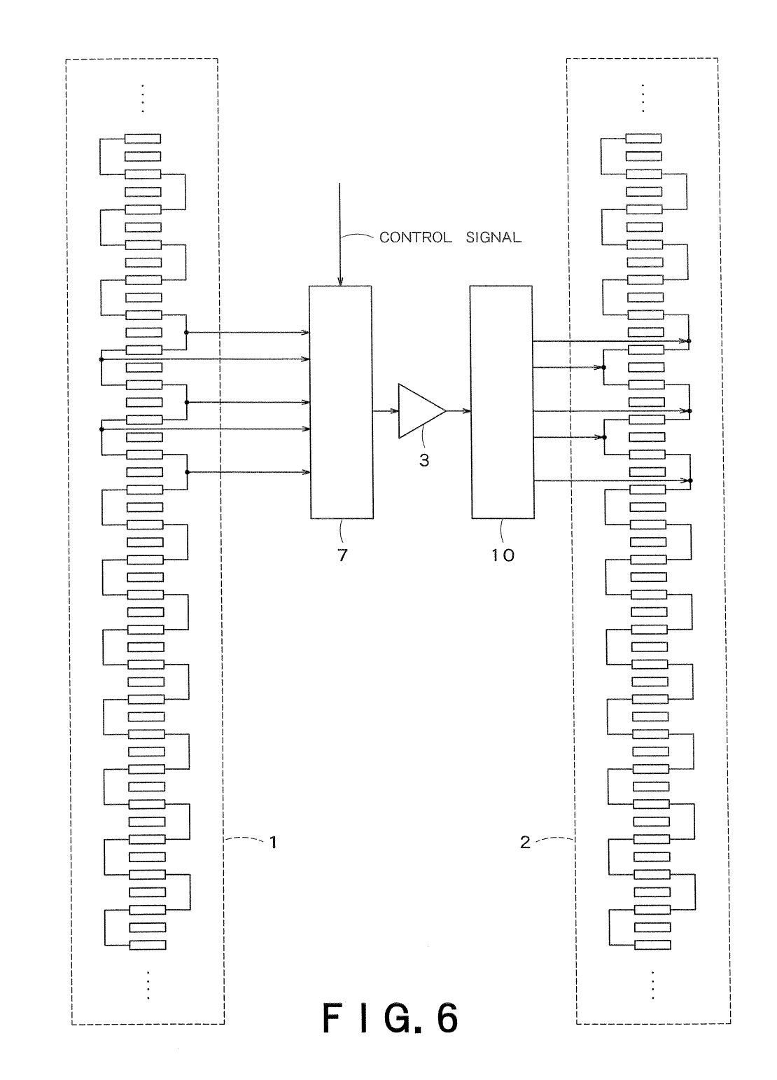

In the example in FIG. 5, the selector 7 receives one of adjacent four voltages that outputted from the output voltages of the gamma-reference-voltage generation circuit 1. When you want rough adjustment of voltage, following is necessary: select the output voltage of the gamma-reference-voltage generation circuit 1 for every a plurality of voltages, and then input the selected output voltages to the selector 7. However, in this case, if the connection is fixed between the output terminal of the operational amplifier 3 and the gamma-correction-voltage generation circuit 2, the voltage difference becomes large between the input and the output voltage of the operational amplifier 3, whereby the current dissipation increases in the operational amplifier 3. Therefore, in this case, as illustrated in FIG. 6, the following is preferable: a selector 10 is provided between the output terminal of the operational amplifier 3 and the gamma-correction-voltage generation circuit 2, so that the selector 10 and 7 switch simultaneously and cooperatively at the output side and at the input side.

In addition, FIG. 5 illustrates an example in which single the selector 7 is shown. However, a plurality of selectors 7 and a plurality of corresponding operational amplifiers 3 may be provided. In this case, the some input terminals of selectors 7 may receive the same voltages from the gamma-reference-voltage generation circuit 1.

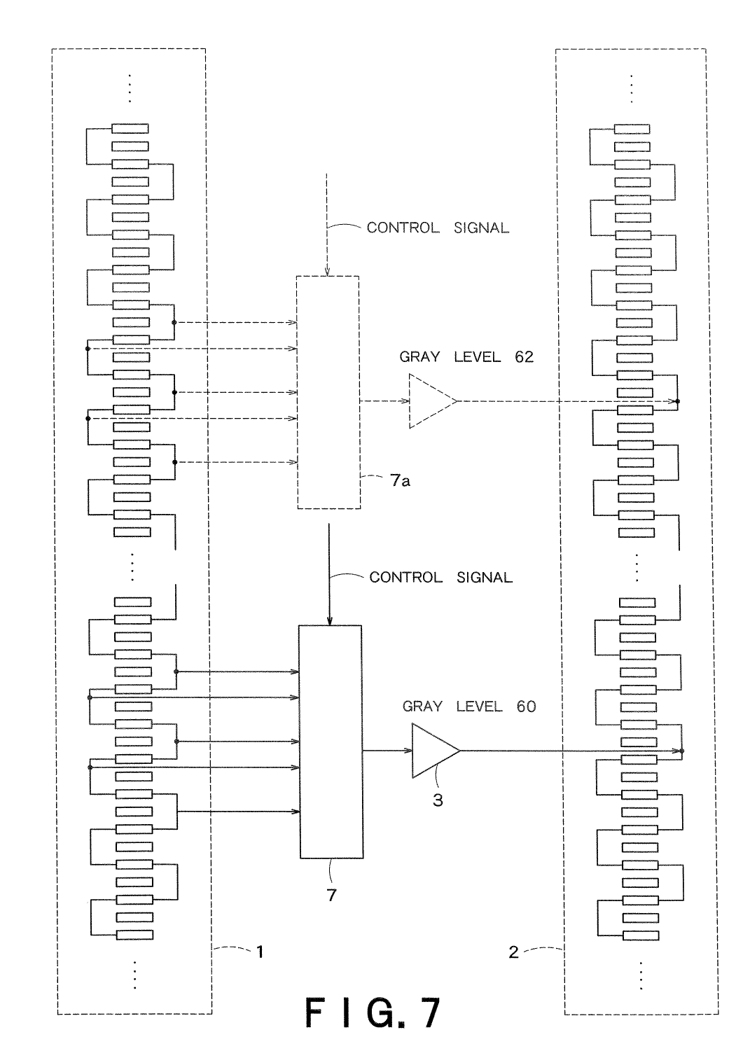

Additionally, the selector 7 may enhance its functionality to partially change the output voltages inputted to the operational amplifier 3 in the gamma-reference-voltage generation circuit 1. As a result, the output voltage varies considerably for the operational amplifier 3 FIG. 7 illustrates an example in which all the output voltages inputted to the selector 7 are replaced for the gamma-reference-voltage generation circuit 1. In FIG. 7, the connections at both the input and the output sides of the selector 7 are replaced from the connection of the dotted lines 7a to the connection of the solid lines 7.

As described above, by simply changing the input and the output wiring for the selector 7, both the voltage adjustment position and the voltage adjustment of the gamma-reference-voltage generation circuit 1 can arbitrarily be changed. The change in the wiring may be realized by changing the positions of wiring conductive strips at the final stage of the manufacturing as mater-slice.

The same circuits are formed for the gamma-reference-voltage generation circuit 1 and the gamma-correction-voltage generation circuit 2. Therefore, even though the connection portions of the selector 7 and the operational amplifier 3 are shifted, no problem occurs with regard to the electric characteristics, whereby the gamma-correction-voltage generation circuit 2 outputs a desired gamma-correction voltage. In addition, even though the connection portions of the selector 7 and the operational amplifier 3 are shifted, the following two voltages are approximately the same: (1) the output voltage of the gamma-reference-voltage generation circuit 1, that is an input to the selector 7, and (2) the input voltage of the gamma-correction-voltage generation circuit 2, that is the output voltage of the operational amplifier 3. Therefore, no extra drivability is required on the operational amplifier 3, whereby current dissipation does not increase.

As discussed above, in the circuit in FIG. 7, by simply changing the input and the output wiring for the selector 7, the gamma-correction voltage can be adjusted over a wide range of gray level. If design contains changes for the resistance values of the unit-resistors in the first resistor unit 4 and the second resistor unit 5 so as to change the gamma-correction voltage, it is conventionally required to reproduce all the mask design including the base film starting from the lowest semiconductor substrate, whereby manufacturing costs for the design change are expensive. In contrast, in the present embodiment, it is necessary to reproduce only the top single mask of aluminum wiring, whereby mast-reproduction costs are small. Accordingly, not only the mask cost is reduced to 1/100 compared to conventional mask reproduction, but also the manufacturing time required for the design change is reduced significantly.

In addition, in the circuit in FIG. 7, in order to change the connection at both the input and the output sides of the selector 7, respective additional un-illustrated selectors may be provided between the gamma-reference-voltage generation circuit 1 and the input terminal of selector 7, and another un-illustrated selectors may be provided between the output terminal of the operational amplifier 3 and the gamma-correction-voltage generation circuit 2. In this case, the connection can programmably be changed at both the input and the output sides of the selector 7. Therefore, there is no need for additional mask reproduction except the top aluminum mask.

Additionally, the selector 7 in the circuit illustrated in FIG. 5 or FIG. 7 may have not only a function of simply selecting the input voltage thereof, but also a function of performing fine adjustment of the selected input voltage.

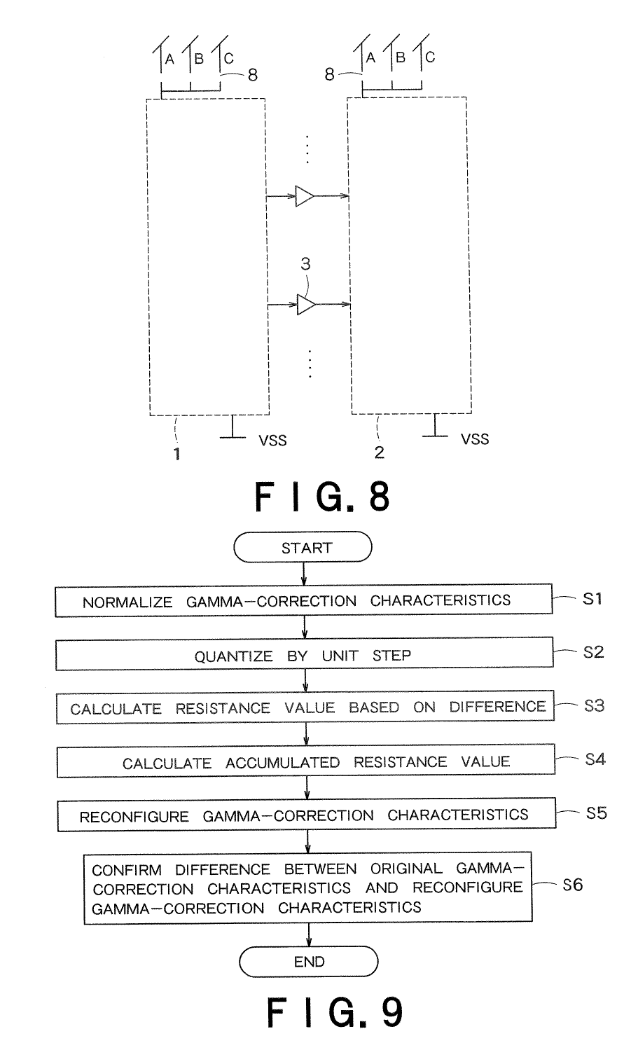

Liquid-crystal panels have respectively different gamma-correction characteristics depending on the liquid-crystal panel types and more particularly the manufacturers. The driving voltages also differ from one another. Accordingly, gamma correction has to be performed corresponding to a gamma-correction characteristics of liquid-crystal panel to be utilized. When a liquid-crystal panel is driven by using of the gamma-correction circuit illustrated in the figures described above FIG. 1, FIG. 5, or FIG. 7, FIG. 8 shows its block configuration.

FIG. 8 is a block diagram illustrating the configuration of gamma-correction circuit corresponding to a plurality of kinds of liquid-crystal panels. Two or more power-supply voltages are supplied corresponding to respective driving voltages for liquid-crystal panels, through switches 8 to the gamma-reference-voltage generation circuit 1 and the gamma-correction-voltage generation circuit 2. One of the switches 8 turns ON in accordance with the type of a liquid-crystal panel to be actually utilized.

In the present embodiment, the amounts of adjustment for gamma correction are set not based on the voltages that are actually supplied to a liquid-crystal panel, but based on the relative values obtained by normalizing the voltages. Accordingly, even though the absolute level varies for the power-supply voltage supplied to the gamma-correction circuit, the actual processing is hardly affected.

FIG. 9 is a flowchart illustrating an example of the procedure of gamma-correction processing according to the present embodiment. The flowchart illustrates the processing procedure performed by an operator manually or by utilizing a computer or the like, in the case that a semiconductor chip is manufactured with a built-in gamma-correction circuit.

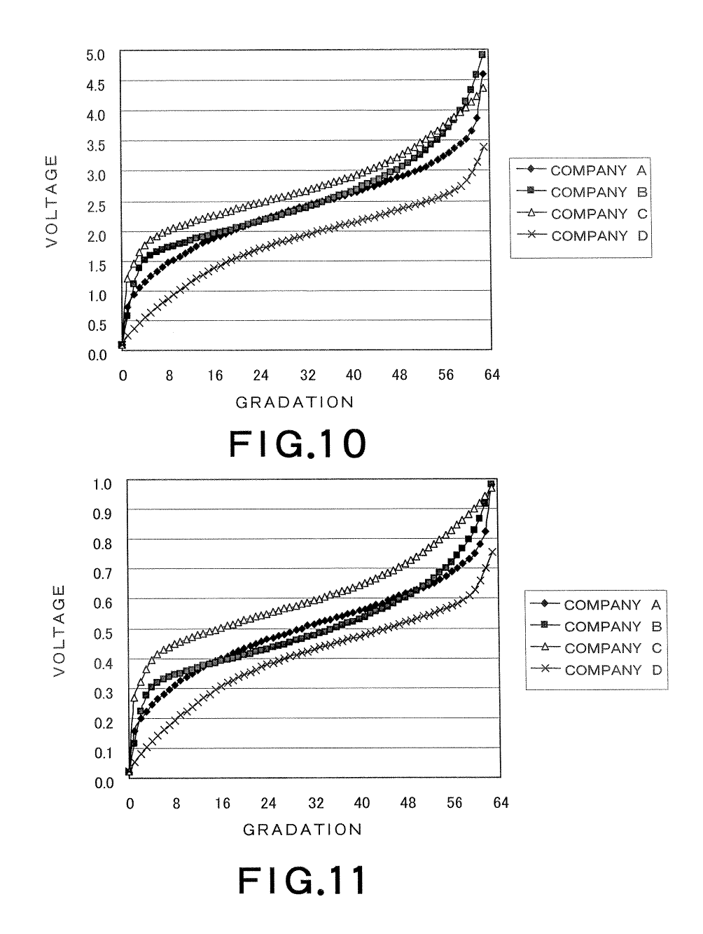

First of all, normalize the gamma-correction characteristics of liquid-crystal panels, which are to be utilized (Step S1). For example, assuming that the gamma-correction characteristics of the liquid-crystal panels are represented in FIG. 10, FIG. 11 represents the results of the normalization. In FIG. 11, the normalization is performed by the procedure that the power-supply voltage supplied to the liquid-crystal panel is set to the relative value (real number) one. FIGS. 10 and 11 each represent gamma-correction characteristic curves for four kinds of liquid-crystal panels produced by manufacturers A, B, C, and D. FIGS. 10 and 11 show that there are different gamma-correction characteristics depending on the kinds of the liquid-crystal panels.

Next, quantize the normalized voltage values to integers measured by unit step value (Step S2). The value one is preferable as unit step value. However, if you want to improve accuracy, the step may be, e.g., 0.5, that is available by parallel connection of two unit-resistors.

In the present embodiment, the step is assumed to be 1/250, for instance. When dealing with 8-bit gray level values, the step is also conceivable to be 1/256. However, by considering the process in which a VT curve (a gray level voltage vs. transmittance characteristic) is physically measured and then the voltage is designated from a graph, 1/250 is more preferable than 1/256. That is because value reading is easy by a basis of ¼, from a graph with scales in 1/100s. But, when the step is 1/256, value reading is difficult from a graph. Thus, the choice of 1/250 is more practical: instead of adopting 1/256 in accordance with 8-bit gray levels, the step is set to 1/250 that is close to 1/256. In addition, the two steps are desirably same for the gamma-reference-voltage generation circuit 1 and the gamma-correction-voltage generation circuit 2. To be supplementary just in case, the above does not mean the exclusion of the step setting 1/256. It is apparent that the step of 1/256 may be adopted.

Next, calculate resistance values based on the difference (voltage difference) between the neighboring gray level voltages (Step S3). A gray level voltage is generated based on a resistor string by the gamma-reference-voltage generation circuit 1 and the gamma-correction-voltage generation circuit 2 Therefore, a gray level voltage is obtained by accumulating the differences between the neighboring gray level voltages. Accordingly, then, calculate the difference between the neighboring gray level voltages. More particularly, the calculated difference should be rounded off.

When allowing parallel connection, it is required to set the unit to 0.5 for example. In this case, double the difference values, and round-off the doubled differences, and then halve the rounded values to return in the original scale.

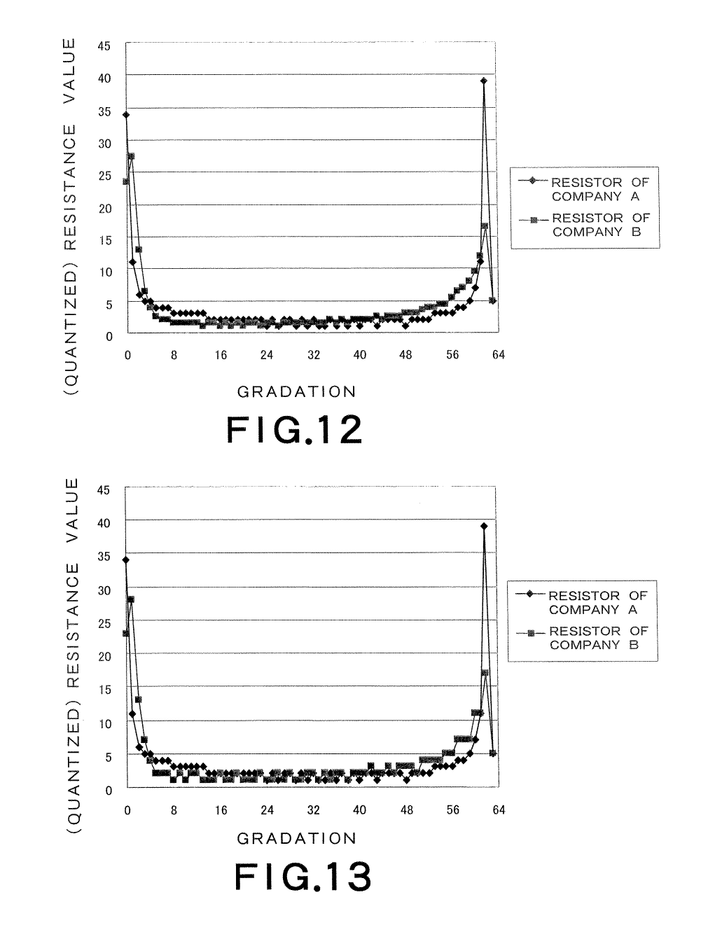

FIGS. 12 and 13 are graphs each representing an example of the result obtained by the processing in Step S3 illustrated in FIG. 9. FIG. 12 is a graph representing the relationship between the gray level value and the resistance value when the step is 0.5: two parallel-connected unit-resistors forms the resistor units respectively in the gamma-reference-voltage generation circuit 1 and the gamma-correction-voltage generation circuit 2. FIG. 13 is a graph representing the relationship between the gray level value and the resistance when the step is one: the respective resistor units have no parallel-connected unit-resistors.

FIGS. 12 and 13 each represent the respective relationships between the gray level voltages for liquid-crystal panels produced by Companies A and B and the resistance values.

The resistance values obtained by the processing in Step S3 illustrated in FIG. 9 are not necessarily a constant value in the intermediate gray levels. Therefore, the present embodiment will not perform broken-line approximation by use of straight lines. In the present embodiment, a curve will be approximated as data with small fluctuation of the curve. Therefore, even if the tap points are moved, as the approximation is not linear as a whole, the approximation can be performed in a more faithful way to the original characteristic curve.

The highest accuracy is required for intermediate gray levels in gamma correction characteristic. Accordingly, when providing parallel-connected unit-resistors in resistor units, intensive preparation of parallel-connected unit-resistors is desirable in the resistor units corresponding to the intermediate gray levels. As a result, the number of the parallel-connected unit-resistors can be reduced, whereby the total number of unit-resistors can also be reduced.

For example, when determining gamma-correction voltages for the liquid-crystal panel supplied from Company B, in the case that no parallel-connected unit-resistors are provided in the resistor units corresponding to the lower gray levels (gray levels of 0 to 7) and the higher gray levels (gray levels of 39 to 63). Then, the number of added resistors can be reduced from 76 to 46, compared to the case where unit-resistors are parallel-connected in each resistor unit. Accordingly, even though extra unit-resistors are added, the total number of unit-resistors can be reduced to 300 or less.

After completed the processing in Step S3 in FIG. 9, calculate the accumulated value of the resistance values obtained in Step S3 (in Step S4). The accumulated value calculates the voltage value outputted from the gamma-correction-voltage generation circuit 2. In this case, the normalization is performed in such a way that the two sums have the value one for the respective total resistance values of the gamma-reference-voltage generation circuit 1 and the gamma-correction-voltage generation circuit 2. Therefore, by multiplying the relative voltage by the power-supply voltage, obtain the absolute value of the gamma-correction voltage (Step S5).

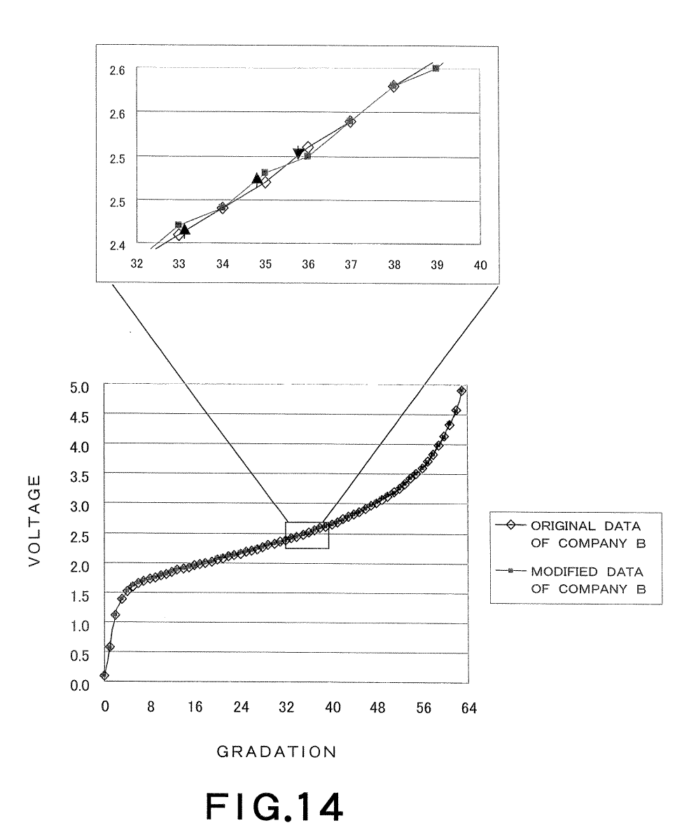

In the above way, characteristics as illustrated in FIG. 14 have been obtained. The abscissa and the ordinate in FIG. 14 denote the gray level value and the gamma correction value, respectively. With regard to the gamma-correction characteristic of a liquid-crystal panel supplied from Company B, FIG. 14 includes the two curves: (1) the original characteristic curve given as a specification from Company B and (2) the characteristic curve reconstructed through the methods in Steps S1 to S4 in FIG. 9. FIG. 14 includes a zoomed view for the intermediate gray levels.

FIG. 14 shows that the reconstructed characteristic curve is very close to the original characteristic curve on the whole, even with small up-and-down fluctuation to the original. The fluctuation is confirmed smaller than approximately 1/500.

In Step S6 in FIG. 9, verify the fluctuation error between the characteristic curves in FIG. 14 by an operator's visual inspection, or by computational inspection of a computer or the like. When the power-supply voltage for the liquid-crystal panel is 5 V and the fluctuation voltage is ±0.01 V, the relative fluctuation error is ±0.01 V/5 V, i.e., 1/500. Accordingly, if the fluctuation error is approximately 1/500, the 8-bit electric accuracy is ensured. If the fluctuation error is larger than 1/500, you should adjust the connection position for the operational amplifier 3 in FIG. 1 or the like so as to change the gamma correction, and then repeat the processing in FIG. 9 until satisfaction for all fluctuation errors.

The gamma-reference-voltage generation circuit 1 described above is provided in order to generate reference voltages to be inputted to the operational amplifier 3. Therefore, a considerable current flow is not necessary in the gamma-reference-voltage generation circuit 1. In contrast, small power of dissipation is desirable for the gamma-correction-voltage generation circuit 2. However, as the gamma-correction-voltage generation circuit 2 is required to have a minimal driving capability at least, a larger current is necessary to flow in the gamma-reference-voltage generation circuit 2 than in the gamma-correction-voltage generation circuit 1. Accordingly, although the two resistance ratio are equal for the resistor strings in the gamma-reference-voltage generation circuits 1 and 2, the two resistance values of each unit-resistor are different for the two gamma-reference-voltage generation circuits 1 and 2.

For example, the two gamma-reference-voltage generation circuits 1 and 2 are assumed to have 250 unit-resistors respectively. If the resistance value of the unit-resistor is 2 kΩ in the gamma-reference-voltage generation circuit 1, the total resistance value is 2 kΩ multiplied by 250, i.e., 500 kΩ and the dissipated current is 5 V/500 kΩ. On the other hand, if the resistance value of the unit-resistor is 1 kΩ in the gamma-correction-voltage generation circuit 2, then the total resistance value is 1 kΩ multiplied by 250, i.e., 250 kΩ and the dissipated current is 5 V/250 kΩ, i.e., 0.02 mA.

As discussed above, the gamma-reference-voltage generation circuits 1 and 2 have the same circuit configuration and therefore the same resistance ratio. However, as the two resistance values of the unit-resistors are different for the gamma-reference-voltage generation circuits 1 and 2, the respective dissipated currents are not identical for the gamma-reference-voltage generation circuits 1 and 2.

In summary, in Embodiment 1, both the circuit configurations and the resistance ratios of the resistor strings has been forced to the same for the gamma-reference-voltage generation circuits 1 and 2, and then the input and output voltages have been forced to the same for the operational amplifier 3 arranged between both the circuits 1 and 2. Therefore, the dissipated current has been reduced well for the operational amplifier 3 in gamma correction. In particular, as the two gamma-reference-voltage generation circuits 1 and 2 form same circuit, it is very easy to change relative connection position, whereby high-flexibility gamma correction has been obtained over a wide range of gray level.

Moreover, control signal can select the input voltage of the operational amplifier 3 by using the selector 7 provided between the gamma-reference-voltage generation circuit 1 and the operational amplifier 3. Therefore, gamma-correction characteristics are adjusted programmably.

Moreover, the two gamma-reference-voltage generation circuits 1 and 2 may be configured with unit-resistors connected in series or in parallel. Therefore, if unit-resistors are preliminarily manufactured in advance as master-slice in rows on a semiconductor substrate, both the circuits is formed by simply connecting the unit-resistors in sequence, whereby gamma-correction circuit is formed in a relatively small area and small fluctuation (small statistical mismatch) of the resistance value. Moreover, the manufacturing process is saved by master-slice approach, whereby the manufacturing yield rate is raised.

### EMBODIMENT 2

Embodiment 1 has explained the gamma-correction circuit in order to perform gamma correction corresponding to a type of liquid-crystal panel. However, Embodiment 2 described below will be characterized by a gamma-correction circuit applicable to a plurality of types of liquid-crystal panels. In addition, even though the objectives are different, e.g., when gamma-correction circuits are shared for respective RGB characteristics, or when a plurality of gamma-correction circuits prepared for respective backlight adjustments corresponding to utilization environments are shared, the technique can also be generally applicable to share gamma-correction circuit.

Here, for the sake of simplicity, the following explanation will discuss gamma-correction circuit treating two types of liquid-crystal panels, but without loss of generality

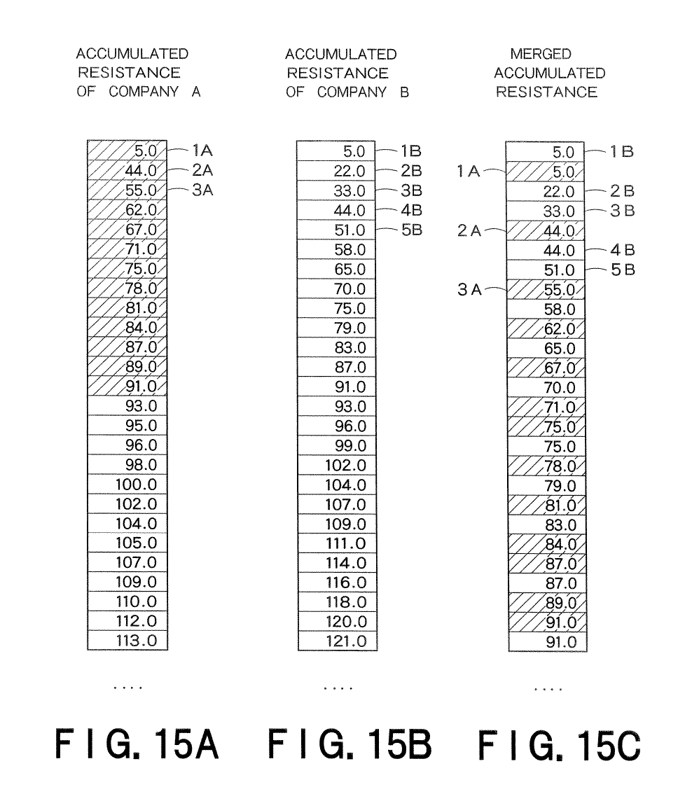

FIG. 15A is a list showing the accumulated resistance values at respective connection nodes in the gamma-reference-voltage generation circuits 1 and 2 corresponding to a liquid-crystal panel manufactured by Company A. FIG. 15B is a list showing the accumulated resistance values at respective connection nodes in the gamma-reference-voltage generation circuits 1 and 2 corresponding to a liquid-crystal panel manufactured by Company B. In addition, FIG. 15C is a merged list in which the accumulated values of respective groups in FIGS. 15A and 15B are rearranged in increasing order.

Reference labels 1A, 2A, and 3A in FIG. 15A denote the respective voltages at the connection nodes between the resistor units. Each voltage is arranged in increasing order starting from the power-supply voltages in the resistor strings for the circuits corresponding to a liquid-crystal panel supplied from Company A. Reference labels 1B to 5B in FIG. 15B denote the respective voltages at the connection nodes between the resistor units. Each voltage is arranged in increasing order starting from the power-supply voltages in the resistor strings for the circuits corresponding to a liquid-crystal panel supplied from Company B.

FIG. 15C represents the merge of accumulated resistance values of a single resistor string that generates the output voltages of the two resistor strings for Companies A and B. All the voltages in FIGS. 15A and 15B are generated from this single resistor string.

Although the resistor strings in FIGS. 15A and 15B may output the same voltage (e.g., the connection nodes 1A and 1B), this means that the same voltage is outputted from the same connection node.

In addition, the connection nodes of the resistor string in both FIG. 15A and FIG. 15B may output different voltages (e.g., the connection nodes 2A and 2B). This corresponds to a case that the voltages are outputted from the different connection nodes, as shown in FIG. 15C. For the two connection nodes, resistor units are connected corresponding to the difference between the two accumulated resistance values.

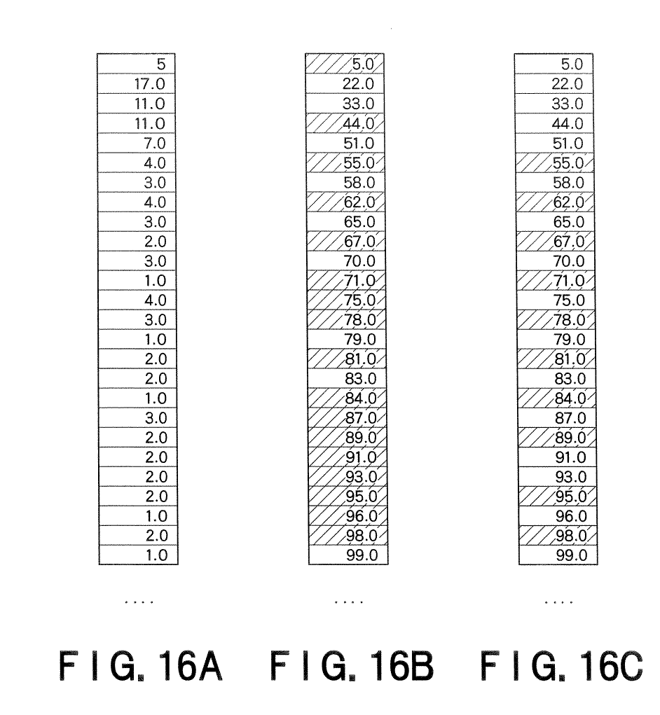

FIGS. 16A, 16B, and 16C give other representation for the resistor string in FIG. 15C. FIG. 16A represents the differences between the accumulated resistance values. In FIG. 16B, a hatched area represents only the connection nodes corresponding to the liquid-crystal panel supplied from Company A. In FIG. 16C, a hatched area represents only the connection nodes corresponding to the liquid-crystal panel supplied from Company B.

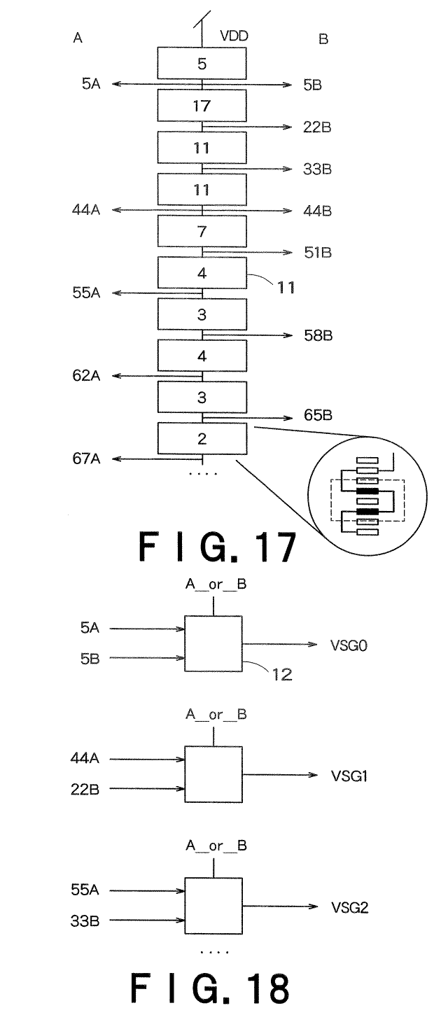

FIG. 17 integrates the results for FIGS. 16A to 16C. A resistor unit is corresponding to box 11 arranged vertically in FIG. 17. The each number in the box 11 denotes the relative resistance value of the resistor units. For example, as zoomed at the bottom in FIG. 17, the number 2 denotes that two unit-resistors have series connection.

The voltages for the liquid-crystal panel supplied from Company A are indicated by the labels 5A, 44A, 55A, 62A, and 67A at the left side in FIG. 17. The voltages for the liquid-crystal panel supplied from Company B are indicated by the labels 5B, 22B, 33B, 44B, 51B, 58B, and 65B at the right side in FIG. 17.

As described above, by preparing a resistor string as illustrated in FIG. 17, reference voltages is selectively generated corresponding to two types of liquid-crystal panels supplied from different manufacturing companies. Selector 12 selects the two types of reference voltages, as illustrated in FIG. 18.

The selector 12 in FIG. 18 selects a gamma-correction voltage corresponding to a liquid-crystal panel supplied from Company A or Company B, in accordance with a control signal supplied from outside. Labels VSG0, VSG1, and VSG2 in FIG. 18 denote reference voltages arranged in decreasing or increasing order of gray level.

In the above-described example, a selection has been explained in which reference voltages are selected corresponding to the one of two types of liquid-crystal panels. However, the present embodiment is also applicable for a case that reference voltages are selected corresponding to the one of three or more types of liquid-crystal panels.

Also in Embodiment 2, as explained with reference to FIG. 5 or the like, the fine adjustment of gamma correction may be obtained by the selector insertion that the selector 7 connects the gamma-reference-voltage generation circuit 1 and the operational amplifier 3.

In the gamma-correction circuit explained with reference to FIG. 1 or the like, the operational amplifier 3 is connected for every a plurality of resistor units in the resistor string. For example, if the operational amplifier 3 is connected for every eight resistor units, then eight operational amplifiers 3 are required for 64 gray levels. Accordingly, as represented in FIGS. 15 to 17, in order to generate gamma-correction voltages corresponding to two types of liquid-crystal panels, a simple arithmetic (eight multiplied by two makes sixteen) suggests the require of 16 operational amplifiers 3.

In this regard, however strictly speaking, the level of the gamma-correction voltage may slightly deviate, all the operational amplifiers 3 are not required to be provided in a pair fashion. In general, a gamma-correction characteristic is approximately linear for intermediate gray levels. Therefore, a gamma-correction voltage can be generated by inputting reference voltages to the same operational amplifier 3, where the reference voltages for liquid-crystal panels have different gamma-correction characteristics. In contrast, for the higher and lower gray levels, gamma-correction characteristic are nonlinear and considerably different depending on liquid-crystal panels. Therefore, the independent operational amplifiers 3 are preferable to provide for generation of a gamma correction voltage.

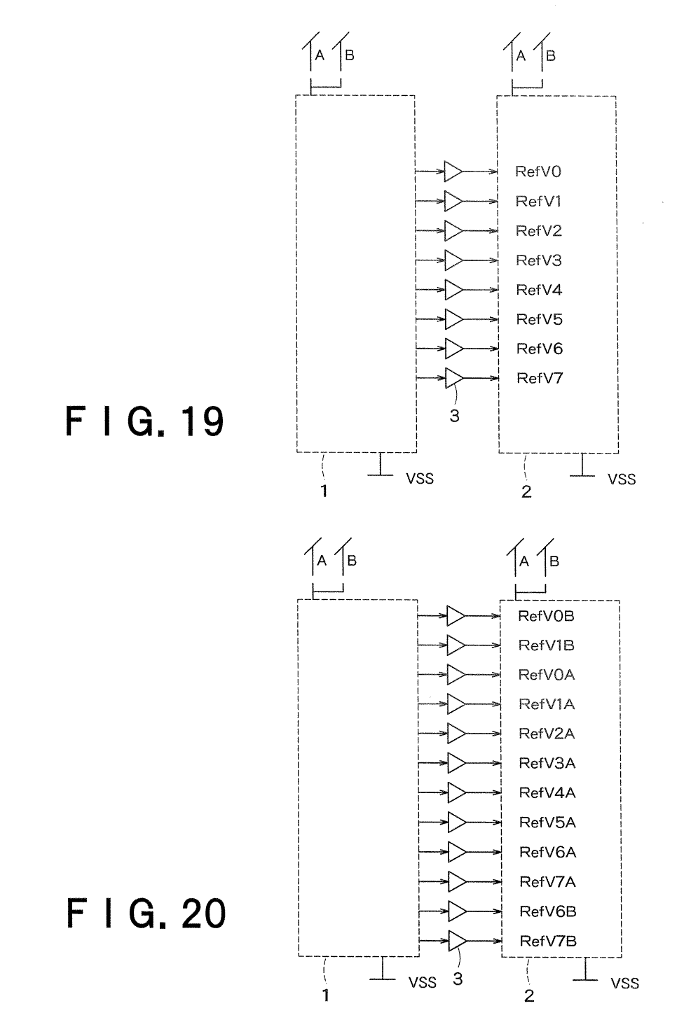

FIG. 19 is a schematic block diagram of gamma-correction circuit when gamma-correction voltages are generated for a single type of liquid-crystal panel. On the other hands, as same as FIG. 17, FIG. 20 is a schematic block diagram of gamma-correction circuit when gamma-correction voltages are generated for two types of liquid-crystal panels.

In the case of FIG. 20, four reference voltages RefV2A to RefV5A are shared for intermediate gray levels, when gamma-correction voltages are generated for two types of liquid-crystal panels. In other words, for each reference voltage, the corresponding single operational amplifier 3 generates gamma-correction voltages for two types of liquid-crystal panels. In contrast, for the higher and the lower gray levels, pairs of reference voltages (RefV0A, RefV0B), (RefV1A, RefV1B), (Ref6A, Ref6B), and (Ref7A, Ref7B) are provided for each liquid-crystal panel. That is, the different operational amplifiers 3 are provided for respective liquid-crystal panels so as to generate gamma-correction voltages.

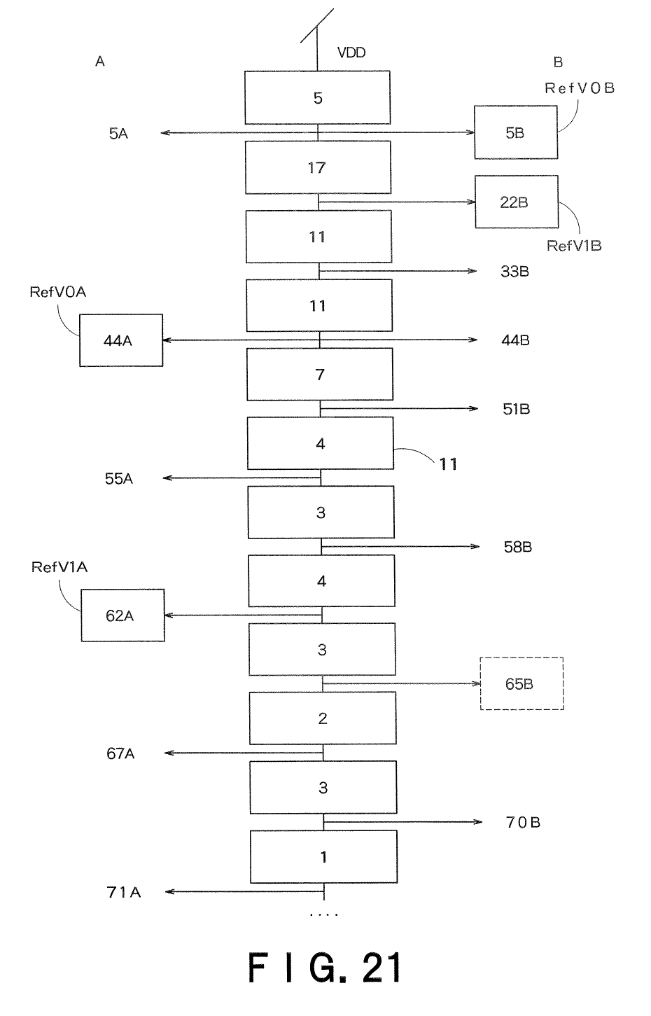

Instead of the control as illustrated in FIG. 20, another approach may be employed: generate eight reference voltages for each of two types of liquid-crystal panels, select the required reference voltages among the reference voltages, and then connect the selected reference voltages with the corresponding operational amplifiers 3. FIG. 21 is a diagram for explaining the approach more specifically. At the left side, there are eight reference voltages 5A, 44A, 55A, 62A, 67A, and 71A corresponding to the liquid-crystal panel supplied from Company A. At the right side, there are eight reference voltages 5B, 22B, 33B, 44B, 51B, 58B, 65B, and 70B corresponding to the liquid-crystal panel supplied from Company B. By forcing 5B to be RefV0B and forcing 22B to be RefV1B, reference voltages are more precisely controlled for the higher gray levels in the liquid-crystal panel supplied from Company B.

In addition, force reference voltages 44A and 62A to be RefV0A and RefV1A respectively. For instance, for the liquid-crystal panel supplied from Company B, a reference voltage is conceivable to be outputted from 65B. However, as 62A is near to 65B, the reference voltage RefV1A may be forced instead. Voltage values are low around 62A, and the gamma-correction characteristics are nearly linear for the two types of liquid-crystal panels. Accordingly, even if either of 62A and 65B is selected, the selection does not make significant difference in the resultant gamma correction.

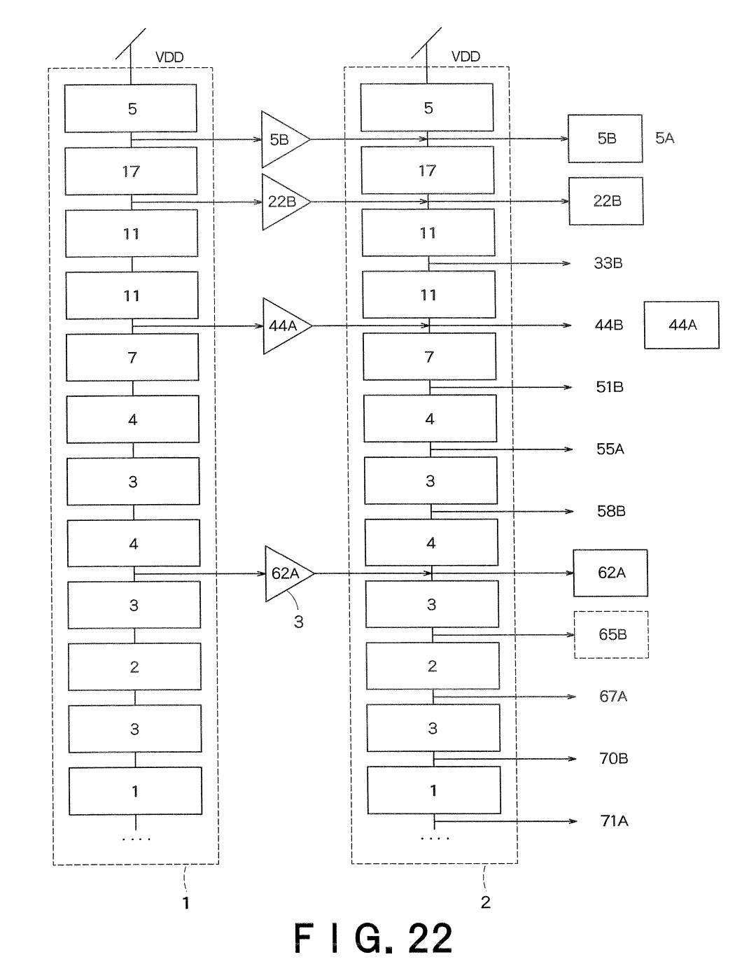

FIG. 22 is a diagram schematically illustrating the configuration of gamma-correction circuit for realizing the approach illustrated in FIG. 21. Resistor strings are provided in the two gamma-reference-voltage generation circuits 1 and 2, and each block of the resistor strings has the number which denotes the count of serially-connected unit-resistors within the block. Four output voltages are explicitly illustrated for the gamma-reference-voltage generation circuit 1. The output voltages are inputted to the corresponding operational amplifiers 3. The outputs of the operational amplifiers 3 are supplied to the corresponding connection nodes in the gamma-correction-voltage generation circuit 2. Based on the output voltages of the operational amplifiers 3 that are located at the first and the third from the top, the gamma-correction voltages (5A, 5B) and (44A, 44B) are generated to be shared by the two types of liquid-crystal panels. The second operational amplifier 3 located from the top is utilized to generate the gamma-correction voltage 22B for the liquid-crystal panel supplied from Company B. And the forth operational amplifier 3 illustrated at lower side is utilized to generate the gamma-correction voltage 62A for the liquid-crystal panel supplied from Company A.

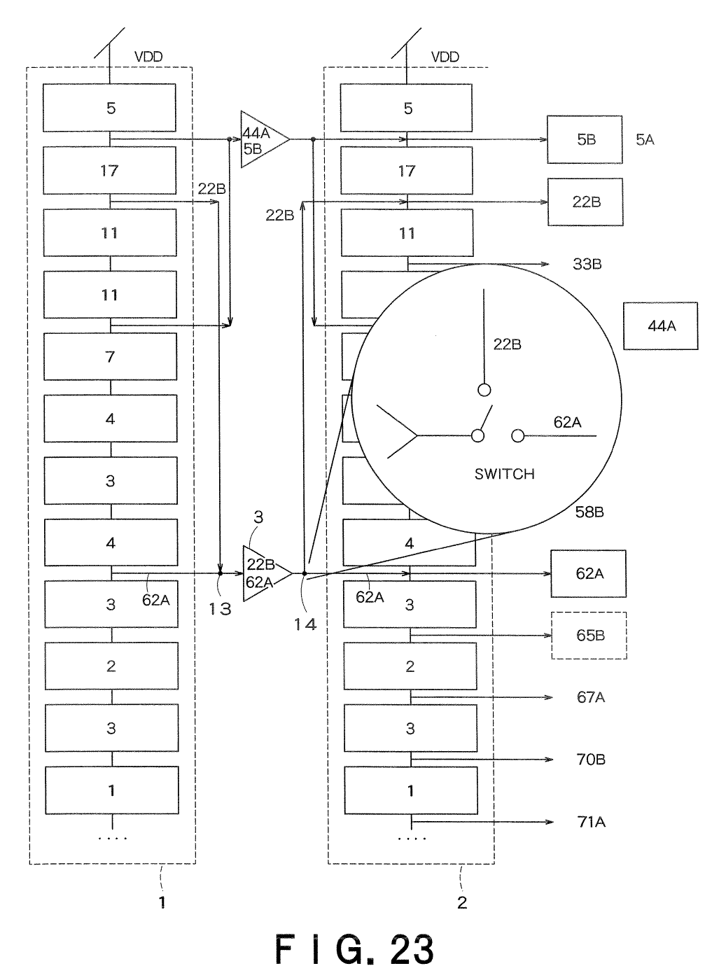

FIG. 23 is a block diagram schematically illustrating a variant configuration of the gamma-correction circuit in FIG. 22. The gamma-correction circuit in FIG. 23 includes two switches: a switch 13 that connects the gamma-reference-voltage generation circuit 1 and the input terminal of the operation amplifier 3 and a switch 14 that connects the operational amplifier 3 and the gamma-correction-voltage generation circuit 2.

The switch 13 selects a voltage from different output voltages for the gamma-reference-voltage generation circuit 1 in order to supply the selected voltage to the input terminal of the operational amplifier 3. On the other hands, the switch 14 selects a voltage of connection nodes in the gamma-correction-voltage generation circuit 2 in order to supply the output voltage of the operational amplifier 3 to the selected node.

In order to reduce the current dissipation, the input and the output voltage of the operational amplifier 3 is desirable to be the same. Thus, the switches 13 and 14 must cooperatively perform the switching. The switching by the switches 13 and 14 may be implemented based on control signals from outside, or may be implemented based on the alternative approach: by changing wiring patterns. For example, the latter case may employ an approach: wiring conductive strips preliminary connects the input terminal of the operational amplifier 3 and respective connection nodes in the gamma-reference-voltage generation circuit 1, and then a laser beam or the like disconnects unnecessary wiring conductive strips.

When the switch 13 is replaced by wiring conductive strips, short wiring length is desirable for the overall length of the wiring conductive strips in order to implement the layout of the wiring conductive strips, and careful arrangement is also desirable for unnecessary wiring conductive strips in order to easily disconnect the wiring conductive strips. The same discussion is applied to the switch 14 located between the output terminal of the operational amplifier 3 and the gamma-correction-voltage generation circuit 2.

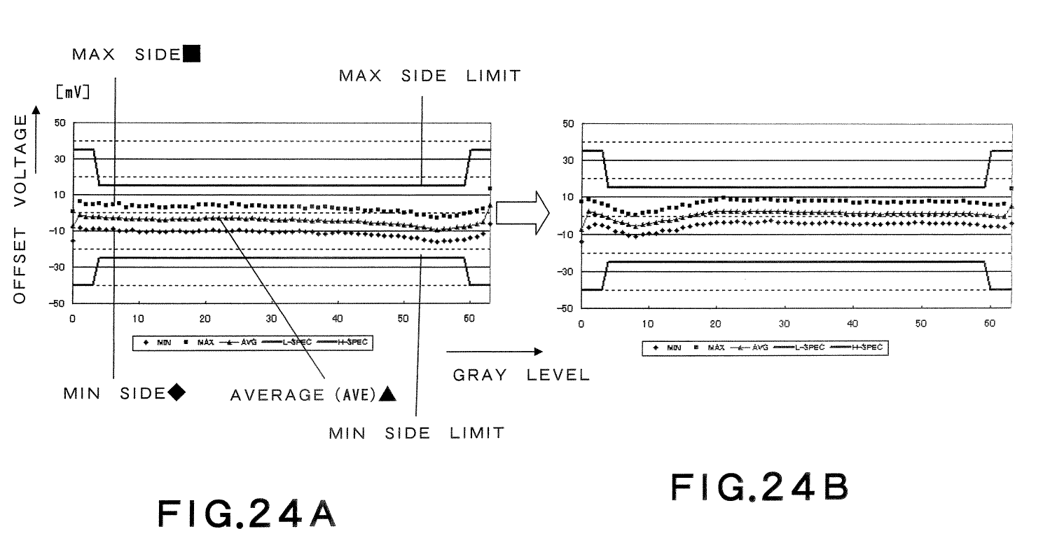

FIG. 24 is a set of graphs representing the results of gamma correction performed according to Embodiment 1 or Embodiment 2 described above. FIG. 24B represents the difference (offset voltage) between the design value and the measured value for gamma-correction characteristic when gamma correction is performed according to the present embodiment of master-slice. FIG. 24A represents the offset voltage for gamma-correction characteristic when conventional gamma correction is performed. In FIGS. 24A and 24B, the abscissa and the ordinate denote the gray level value and the offset voltage respectively.

As seen from FIG. 24, the offset voltage of the present embodiment is reduced over the whole range of 64 gray levels, compared with the offset voltage of a conventional method.

As summary, as discussed above, in Embodiment 2, a single gamma-correction circuit can generate gamma-correction voltages for a plurality of liquid-crystal panels. Therefore, there is no need to provide multiple individual gamma-correction circuits dedicated for each liquid-crystal panel, whereby its usability of the gamma-correction circuit is enhanced.

### EMBODIMENT 3

The gamma-correction circuits explained in Embodiment 1 or Embodiment 2 will be incorporated, e.g., in a driver IC that drives a liquid-crystal panel.

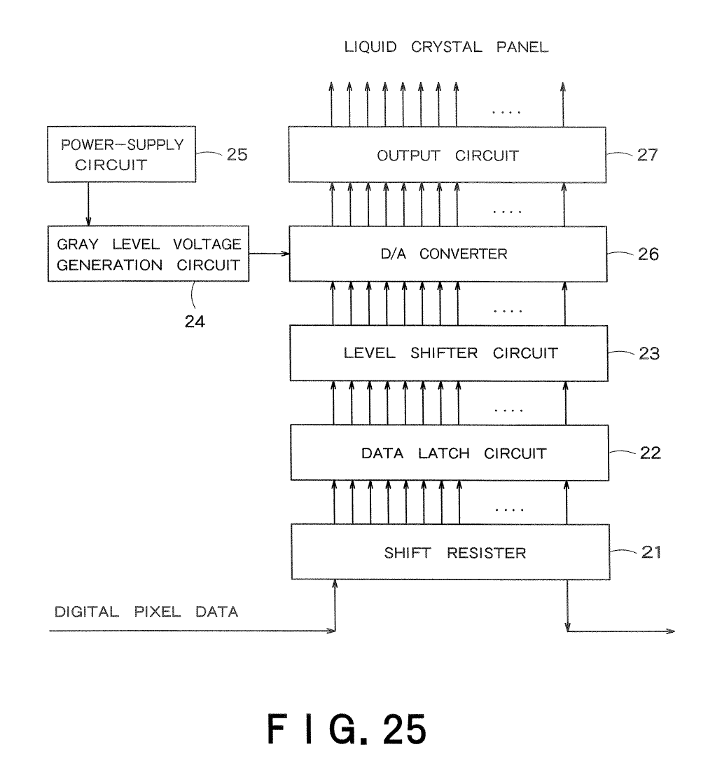

FIG. 25 is a block diagram illustrating a schematic configuration of such a driver IC. The driver IC in FIG. 25 includes the following circuits: (1) a shift register 21 that sequentially transfers digital pixel data for each pixel, (2) a data latch circuit 22 that latches the digital pixel data transferred by the shift register 21 in a predetermined format of pixels, (3) a level shifter circuit 23 that converts the output voltage level of the data latch circuit 22 into the driving voltage level for the liquid-crystal panel, (4) a gray level voltage generation circuit 24 that generates reference gray level voltages for gray level rendering, (5) a power-supply circuit 25 that generates references for gray level voltages, (6) a D/A converter 26 that selects a gray level voltage corresponding to the data bit value (gray level value) of digital pixel, and (7) an output circuit 27 that adjusts the drivability of the gray level voltage outputted from the D/A converter 26. The outputted gray level voltage from the output circuit 27 is supplied to a corresponding signal line in the liquid-crystal panel.

The gamma-correction circuits explained in Embodiment 1 and Embodiment 2 are provided in the gray level voltage generation circuit 24 in FIG. 25. The gray level voltage generation circuit 24 generates the adjusted gray level voltage in order to match the gamma-correction characteristic of the liquid-crystal panel.

The power-supply circuit 25 that supplies a power-supply voltage to the gray level-voltage generation circuit 24 may be provided in the same driver IC or in another chip.

The driver IC according to the present embodiment may be mounted, for example, in the frame portion of the liquid-crystal panel. Alternatively, another method may be employed: the driver IC is mounted on a board separated from the liquid-crystal panel, and the driver IC sends a signal to and receives a signal from the liquid-crystal panel via a FPC (Flexible Printed Circuit) or the like.

In summary, as discussed above, each of the gamma-correction circuits explained in Embodiment 1 and Embodiment 2 can be incorporated in a driver IC that drives a liquid-crystal panel. Therefore, high-accuracy gamma correction is performed in the driver IC, without considerable increasing of power consumption in the driver IC.

Finally, each embodiment described above has explained an example how to implement gamma correction for a liquid-crystal panel. However, the present invention is widely applicable to any of other various kinds of flat display devices (such as an EL device and a plasma display device) other than a liquid-crystal display device.

What is claimed is:

1. A gamma-correction circuit, comprising:
a gamma-reference voltage generation circuit capable of outputting voltages from connection nodes between a plurality of first resistor units connected in cascade;
a gamma-correction voltage generation circuit configured to output gray level voltages from connection nodes between a plurality of second resistor units connected in cascade, the second resistor units having the same circuit configuration as the gamma-reference voltage generation circuit and having the same resistance ratio as that of the plurality of first resistor units; and
at least one buffer connected between at least one connection node of the gamma-reference voltage and the corresponding connection node of the gamma-correction voltage.

2. The gamma-correction circuit according to claim 1,
wherein at least one of the plurality of first resistor units has a plurality of unit-resistors connected in series or in parallel; and
at least one of the plurality of second resistor units has a plurality of unit-resistors connected in series or in parallel.

3. The gamma-correction circuit according to claim 1,
wherein the buffer outputs a signal, the signal having the same voltage level as that of the corresponding connection node of the gamma-reference voltage generation circuit and having an increased driving power, from the corresponding connection node of the gamma-correction voltage generation circuit.

4. The gamma-correction circuit according to claim 1,
wherein the buffer is provided one for every a plurality of connection nodes among the connection nodes between the first resistor units.

5. The gamma-correction circuit according to claim 1,
wherein a plurality of buffers are provided between at least one connection node of the gamma-reference voltage and the corresponding connection node of the gamma-correction voltage, the buffers being intensively arranged to the connection nodes in the gamma-reference voltage generation circuit, the connection nodes corresponding to intermediate gray levels.

6. The gamma-correction circuit according to claim 1, further comprising:
a first selector configured to select one among a plurality of output voltages of the gamma-reference voltage generation circuit to supply the selected voltage to the corresponding buffer.

7. The gamma-correction circuit according to claim 6,
wherein an output terminal of the buffer, to which the output voltage selected by the first selector is supplied, is connected to the connection node predetermined in the gamma-correction voltage generation circuit.

8. The gamma-correction circuit according to claim 6, further comprising:
a second selector configured to select the connection node of the gamma-correction voltage generation circuit, the selected connection node having the same voltage level as the output voltage selected by the first selector, the second selector being connected between the buffer and a plurality of connection nodes in the gamma correction-voltage generation circuit.

9. The gamma-correction circuit according to claim 1, further comprising:
a third selector configured to perform selection of the connection node of the gamma-reference voltage generation circuit inputted to the buffer and selection of the connection node of the gamma-correction voltage generation circuit outputted from the buffer for each of a plurality of gamma-correction characteristics different from each other.

10. The gamma-correction circuit according to claim 1,
wherein a plurality of buffers are provided between at least one connection node of the gamma-reference voltage and the corresponding connection node of the gamma-correction voltage, one portion of the buffers being commonly used for a plurality of gamma-correction characteristics, and another portion of the buffers being used for individual gamma-correction characteristics.

11. A display panel control circuit, comprising:
a latch circuit configured to latch digital pixel data including gray level information;
a gray level voltage generation circuit configured to generate gray level voltages;
a D/A converter configured to select the gray level voltage in accordance with a bit value of the digital pixel data latched by the latch circuit; and
an output circuit configured to adjust output level of the D/A converter to supply the output level to the corresponding signal line in a display panel,
wherein the gray level voltage generation circuit has a gamma correction circuit configured to correct voltage levels of a plurality of reference voltages in conformity to gamma-correction characteristics of the display panel to generate the gray level voltages, the gamma correction circuit including:
a gamma-reference voltage generation circuit capable of outputting the voltages from the connection nodes between a plurality of first resistor units connected in cascade;
a gamma-correction voltage generation circuit configured to output the gray level voltages from the connection nodes between a plurality of second resistor units connected in cascade, the second resistor units having the same resistance ratio as that of the first resistor units, the gamma-correction voltage generation circuit having the same circuit configuration as that of the gamma-reference voltage generation circuit; and
at least one buffer connected between at least one connection node of the gamma -reference voltage generation circuit and the connection node of the gamma-correction voltage generation circuit.

12. The display panel control circuit according to claim 11,
wherein at least one of the plurality of first resistor units has a plurality of unit-resistors connected in series or in parallel; and
at least one of the plurality of second resistor units has a plurality of unit-resistors connected in series or in parallel.

13. The display panel control circuit according to claim 11,
wherein the buffer outputs a signal, the signal having the same voltage level as that of the corresponding connection node of the gamma-reference voltage generation circuit and having an increased driving power, from the corresponding connection node of the gamma-correction voltage generation circuit.

14. The display panel control circuit according to claim 11,
wherein the buffer is provided one for every a plurality of connection nodes among the connection nodes between the first resistor units.

15. The display panel control circuit according to claim 11,
wherein a plurality of buffers are provided between at least one connection node of the gamma-reference voltage and the corresponding connection node of the gamma-correction voltage, the buffers being intensively arranged to the connection nodes in the gamma-reference voltage generation circuit, the connection nodes corresponding to intermediate gray levels.

16. The display panel control circuit according to claim 11, further comprising:
a first selector configured to select one among a plurality of output voltages of the gamma-reference voltage generation circuit to supply the selected voltage to the corresponding buffer.

17. The display panel control circuit according to claim 16,
wherein an output terminal of the buffer, to which the output voltage selected by the first selector is supplied, is connected to the connection node predetermined in the gamma-correction voltage generation circuit.

18. The display panel control circuit according to claim 16, further comprising:
a second selector configured to select the connection node of the gamma-correction voltage generation circuit, the selected connection node having the same voltage level as the output voltage selected by the first selector, the second selector being connected between the buffer and a plurality of connection nodes in the gamma correction-voltage generation circuit.

19. The display panel control circuit according to claim 11, further comprising:
a third selector configured to perform selection of the connection node of the gamma-reference voltage generation circuit inputted to the buffer and selection of the connection node of the gamma-correction voltage generation circuit outputted from the buffer for each of a plurality of gamma-correction characteristics different from each other.

20. The display panel control circuit according to claim 11,
wherein a plurality of buffers are provided between at least one connection node of the gamma-reference voltage and the corresponding connection node of the gamma-correction voltage, one portion of the buffers being commonly used for a plurality of gamma-correction characteristics, and another portion of the buffers being used for individual gamma-correction characteristics.
